(19) United States
(12) Patent Application Publication
(10) Pub. No.: US 2021/0394712 A1
(43) Pub. Date: Dec. 23, 2021

(54) VEHICLE LOCK AND METHOD FOR ACCESS-CONTROLLED LOADING AND/OR UNLOADING

(71) Applicant: Kiekert AG, Heiligenhaus (DE)

(72) Inventors: Thorsten Blömer, Köln (DE); Maurizio Chimento, Velbert (DE); Jessica Dirkschnieder, Wuppertal (DE); Marco Eggert, Düsseldorf (DE); David Sommer, Köln (DE); Andreas Ziganki, Mettmann (DE); Volker Westerwick, Bochum (DE)

(21) Appl. No.: 16/472,239

(22) PCT Filed: Dec. 1, 2017
(86) PCT No.: PCT/DE2017/101037

§ 371 Date: Jun. 21, 2019

(30) Foreign Application Priority Data
Dec. 23, 2016 (DE) 10 2016 015 444.6

(51) Int. Cl. B60R 25/24; B60R 25/30; B60R 25/104; E05B 85/26; E05F 15/70; E05B 83/18; E05B 81/56

(52) U.S. Cl. CPC B60R 25/24; B60R 25/305; B60R 25/104; E05B 85/26; E05F 15/70; E05B 83/18; B60R 2025/1013; B60R 2325/205; B60R 2325/103; B60R 2325/105; B60R 2325/101; B60R 2325/106; E05B 81/56

(57) ABSTRACT

A vehicle lock includes a locking mechanism with a rotary latch and a pawl for latching the rotary latch when the vehicle lock is in a closed state, a receiver for receiving a reference code, a code transfer interface for obtaining an access code and a control unit which is configured such that the vehicle lock assumes an unlocked state when the obtained access code matches the reference code. The locking mechanism is used in a method for access-controlled loading and/or unloading of a vehicle. A high degree of automation of an access-controlled process for loading and/or unloading a vehicle can thus be achieved substantially with the aid of the vehicle lock.

The invention relates to a vehicle lock comprising a locking mechanism with a rotary latch and a pawl for latching the rotary latch, and a method for access-controlled loading and/or unloading a vehicle.

The automation of the transportation of goods and shipments has been increasing rapidly for several years. With large online mail order companies, logistics and parcel services, a high level of automation can already been seen in the handling, moving and tracking of every single shipment, whereby in these areas in particular automation continues to be pushed forward in order to achieve the cost savings potentials. The increased automation of goods movements is however also forecast for processes in ordinary private households that are not yet automated, for instance a self-refillable refrigerator or the like.

The transportation of goods and shipments, that can also simply be called a load, is generally realized using vehicles, whereby a loading area or a trunk is usually used to store the load for transport purposes. An access door or access flap provides access to the loading area or trunk so that the load can be loaded and/or unloaded. It is in principle also conceivable that the access door or access flap provides access to a loading space of the vehicle, that is available in addition to the loading area or trunk. The goods and shipments that can be loaded into the vehicle, are generally goods that have been ordered and require storage, such as for example clothes, electronic devices or food items that require storage, this can however also be food items intended for imminent consumption or mail items that are either loaded into the vehicle or unloaded from it.

The access door or access flap is usually secured by a lock with a rotary latch and pawl to prevent unwanted opening during travel or prevent access by unauthorized persons.

The object of the invention is to provide a further developed vehicle lock that facilitates a higher degree of automation when loading a vehicle. The further developed vehicle lock specifically enables the vehicle into which the vehicle lock is installed, to be used as a delivery address for goods and shipments.

The solution to the subject matter is a vehicle lock with the features of the main claim and a method with the features of the additional claim. Advantageous embodiments result from the sub-claims.

The aforementioned features known from the state of the art can be combined individually or in any combination with one of the objects according to the invention described hereafter.

The object is solved by a vehicle lock comprising a locking mechanism with a rotary latch and a pawl for latching the rotary latch when the vehicle lock is in a closed state, a receiver for receiving a reference code for a loading and/or unloading process, a code transfer interface for obtaining an access code and a control unit which is configured such that the vehicle lock assumes an unlocked state when the obtained access code matches the reference code. The receiver is preferably surrounded by a housing of the vehicle lock or directly connected to the housing. “Directly connected to the housing” in this context should be understood in that the receiving unit is positioned in the immediate vicinity of the housing of the vehicle lock and is connected to it by means of connectors, for example screwed to the vehicle lock with screws as fasteners. A direct connection to the housing can for example be used for a retrofit of an existing vehicle lock with a receiving unit. In an alternative version, the receiving unit can be separate to the vehicle lock, for example integrated in the vehicle electronics and connected to the vehicle lock via a data line.

A vehicle lock generally has a closed state, an open state, a locked state and/or an unlocked state.

When the vehicle lock is in the closed state, the rotary latch has accommodated a locking bolt and is held in a latched position by the pawl, i.e. for example in a main latched position or pre-latched position, so that a vehicle door or vehicle flap in a closed position cannot inadvertently open during travel through the vehicle lock.

If the pawl is initiated so that the pawl no longer holds the rotary latch in the latched position and the rotary latch subsequently releases the locking bolt again, then the vehicle lock has assumed the open state. The vehicle door or vehicle flap is then no longer held in the closed position by the vehicle lock, but can assume an open position.

If the vehicle lock is simultaneously in the closed state and unlocked state, the vehicle lock can be moved to the open state to open the vehicle door or vehicle flap, for example by an automatic opening device or by manually actuating an internal or external activation lever.

If the vehicle lock is simultaneously in the closed state and locked state, then the vehicle lock cannot be moved to the open state until the vehicle lock has been switched to the unlocked state.

A receiver for receiving a reference code for the loading and/or unloading process is generally an electronic device that can receive and preferably also process a signal, which contains a reference code, so that the reference code can be transmitted to the control unit. Alternatively, a receiver can also be a manual input device or external data interface such as a USB connection. The current receiver is however preferably configured in such a way that the receiver can receive a signal in the form of electromagnetic radiation within a predefined frequency range and can also convert it to a digital signal. Above all, the receiver is connected to the control unit via a data line.

Reference code and/or access code implies a multi-digit, binary or digital code, notably with at least 4, preferably 6, better even 8 digits or bytes, e.g. “1234”. A “reference code for loading” in this context is a reference code that is designed to allow the vehicle lock to be opened in order to be able to load the vehicle in question. A “reference code for unloading” in this context is a reference code that is designed to allow the vehicle lock to be opened in order to be able to unload the vehicle in question. The unloading of the vehicle by a person other than the driver of the vehicle can for instance occur in order to return a shipment or to use the vehicle as a pick-up address for deliveries for persons other than the driver of the vehicle. It may also be possible that a reference code is intended for a combined loading and unloading process, where one or more shipments are loaded into the vehicle and one or more other shipments are removed from the vehicle. The reference codes are intended for use by a person other than the driver of the vehicle.

A code transfer interface for receiving an access code is generally an electronic device that can receive and preferably also process a signal, which contains an access code, so that the access code can be transmitted to the control unit.

Alternatively, a code transfer interface can also be a manual input device or external data interface such as a USB connection.

The current code transfer interface is however preferably configured in such a way that the code transfer interface can receive a signal in the form of electromagnetic radiation within a predefined frequency range and can also convert it to a digital signal. Above all, the code transfer interface is connected to the control unit via a data line.

Obtained access code is the code that the code transfer interface has received. If for example an access code is transferred incorrectly, then the obtained access code is not the same as the access code that has been transferred to the code transfer interface. Based on the example of a manual code entry, this would correspond to a typing error when the code is entered.

A control unit is generally an electronic device with a processor and memory. Above all, the control unit can include means, such as for example a loadable program code or a computer program product with a loadable program code section, in order to process steps, if the means is performed in a microprocessor-based component. The corresponding software program product is a separate aspect of the invention.

A process step that can be processed by the control unit, includes comparing whether the obtained access code matches the reference code. If it matches, then this triggers the vehicle lock to assume an unlocked state.

The control unit that is configured in such a way that when the obtained access code matches the reference code, the vehicle lock assumes an unlocked state, in other words sends a signal to unlock the vehicle lock when the access code matches the reference code. The receiver of this signal is notably a locking control device, e.g. the central locking system, the DCU (Door Control Unit) or ECU (Electronic Control Unit) of the vehicle.

The vehicle door or vehicle flap that preferably goes to the loading area or trunk, can then for example be opened for loading by an automatic opening device or through the manual actuation of an actuating lever.

A vehicle lock comprising a locking mechanism with a rotary latch and a pawl for latching the rotary latch when the vehicle lock is in a closed state, a receiver for receiving a reference code, a code transfer interface for receiving an access code and a control unit that is configured in such a way that when the obtained access code matches the reference code, the vehicle lock assumes an unlocked state, and access-controlled loading of a vehicle is facilitated with a very high degree of automation, that however requires very little or even no adaptations to the other vehicle components. The access-controlled loading of the vehicle can consequently be offered as an optional and/or retrofittable equipment variant. Also, no additional installation space is required for complex installations for access control, which means that an extremely compact solution can be retained through the vehicle lock according to the invention. Loading is therefore access-controlled, not only for carriers, in other words persons, but also robots or drones.

Thus, in a supermarket, an employee can for example already load the purchases from a shopper into the vehicle of the shopper, after the reference code has been sent from the supermarket to the vehicle lock. The shopper no longer has to hand over his vehicle keys to the employee. This prevents any misuse.

In the mail order business or parcel services, the reference code can for example be sent from a load issuing station to a delivery vehicle designated for the delivery of a load. The load can then be forwarded to a loading carrier in order to transport the load from the load issuing station to the said delivery vehicle, to then load it there and to return to the load issuing station.

The delivery vehicles can thereby remain securely locked to prevent possible theft.

The load is generally a shipment, package or goods that are to be loaded into a vehicle for transportation.

The loading carrier is generally a person or equipment for transporting a load to a vehicle and for loading the load into the vehicle, e.g. a robot or drone.

In one embodiment, the receiver is configured such that the reference code can be sent contactless and/or from a distance of at least 100 m, preferably 1000 m, better even 10000 m, to the receiver.

A load issuing station can hereby send reference codes to a very large number of vehicles. As an alternative to the load issuing station, the reference code can be sent by an external sending station.

In one embodiment, the receiver includes a SIM card slot for a SIM card or eSIM and/or mobile telephone unit.

A SIM (Subscriber identity module) is a chip card that is usually used in mobile telephones. An eSIM (embedded SIM) is a fixed chip card that cannot be replaced, whereby the eSIM is generally assigned to a SIM card.

A mobile telephone unit is used to receive and basically also send a mobile signal within the frequency range of electromagnetic radiation designated for mobile communication. Above all, the mobile telephone unit is set up as M2M (Machine to Machine), in order to guarantee the extremely reliable and direct transmission of the reference code from a sender unit to the receiver.

A receiver with a SIM card slot for a SIM card or eSIM and/or a mobile telephone unit facilitates the extremely reliable transmission of the reference code to the vehicle lock and the extremely simple management of several vehicles with a vehicle lock according to the invention at the load issuing station.

In one embodiment, the code transfer interface is configured such that the access code can be transmitted contactless to the code transfer interface.

The vehicle lock is generally, with the exception of the outside operating lever, positioned in the interior of the vehicle, in other words within the external surface of the vehicle and only becomes visible and accessible after the vehicle door or flap is opened. Entering an access code via an input device would therefore require an additional, external component that would have to be weatherproof and affixed to the outside of the vehicle. This would however be very complex. The contactless transmission of the access code to the code transfer interface enables the access code to be received and processed by the actual control unit of the vehicle lock, without having to first open the vehicle door or flap or also provide additional external components.

In one embodiment, the code transfer interface is configured such that the access code can only be transmitted within a distance from the vehicle lock that is less than 100 m, preferably less than 10 m, even better, less than 1 m, to the code transfer interface.

This allows contactless data communication technologies to be used that are cost-effective and extremely easy to use. Also, this prevents for example when an automatic opening device is provided, the vehicle door or flap from opening prematurely if the loading carrier is not even within sight of the vehicle.

An access code unit of the loading carrier is used in particular to transfer the access code to the code transfer interface.

In one embodiment, the code transfer interface is an NFC interface (Near Field Communication), an RFID interface (radio-frequency identification), a Bluetooth interface and/or a WLAN interface (Wireless Local Area Network).

A robot or drone can hereby easily obtain access to the loading area or trunk of the vehicle. A person too who is generally carrying the load in both hands, does not have to first of all put down the load to enter the access code.

An NFC interface is notably a receiver module that can receive data via electromagnetic induction, preferably by means of loosely coupled coils across a short distance of for instance a few centimeters, so less than 10 cm, that uses the international transmission standard for the contactless exchange of data based on the RFID technology and/or that achieves a data transmission rate of maximum 424 kbit/s.

An RFID interface is notably an RFID reader for an RFID tag as access code unit of the loading carrier, also called an RFID transponder. The RFID transponder is made up of in particular an antenna, an analog switching circuit for receiving and sending (transceiver) and/or a digital switching circuit and a memory, for example to save the access code. The digital switching circuit can be a microcontroller. RFID transponders generally have a memory that is writable at least once, that preferably contains the access code temporarily or permanently.

Above all, the RFID transponder is an active RFID tag with a separate power supply or a passive RFID tag that uses the high frequency energy absorbed by it during the communication process as power supply. A semi-active RFID tag too can also be converted, where a battery is used to cover the supply of part of the power requirement.

The microchip in particular in the RFID tag decodes the commands sent by the RFID reader and codes and/or modulates the response, in other words the access code, into the irradiated electromagnetic field through field weakening in the contactless short-circuit or anti-phase reflexion of the field sent by the RFID reader. The RFID tag itself does not create a field but influences the electromagnetic sending field of the RFID reader.

This enables the loading carrier to easily transfer the access code, thus also preventing any transmission errors.

A Bluetooth interface and/or a WLAN interface allow Smartphones or portable Tablet PCs to be used for controlled loading.

The access code unit of the loading carrier is therefore notably an RFID tag or NFC tag or a Smartphone or Tablet PC equipped with a Bluetooth interface and/or WLAN interface.

In one embodiment, the control unit is configured in such a way that when the obtained access code matches the reference code, the control unit sends a signal to unlock a loading area or trunk.

A loading area or trunk can for example be unlocked by blocking a rear seat bench, e.g. via a microdrive and/or by raising and/or securing headrests for the rear seat bench.

Once the loading carrier gains access to the loading area or trunk, the loading carrier cannot then gain access further into the main body of the vehicle. This prevents possible misuse and theft of items from the main part of the vehicle.

In one embodiment, the control unit is configured in such a way that when the obtained access code matches the reference code, the control unit sends a signal to an opening device to automatically open a vehicle door or flap.

The vehicle door or flap are notably used for opening and closing an access point to a loading area or trunk. In an alternative embodiment, a separate loading box can also be provided, with a separate vehicle door or flap for loading, unloading and storing the load during transportation with the vehicle.

A robot or drone can hereby easily convey the load to the loading area or into the trunk. A person too who is generally carrying the load in both hands, does not have to first of all put down the load to open the vehicle door or flap.

The locking of the loading area or trunk takes place before switching the vehicle lock to the unlocked state and/or before sending the signal to the opening device for the automatic opening operation.

In one embodiment, the control unit is configured in such a way that once loading has been completed, the control unit then sends a signal to a locking device to automatically close the vehicle door or flap.

The opening and locking device are one and the same opening and locking device that is preferably powered electrically.

Once loading has been completed means the point in time when the load is actually in the vehicle and the loading carrier is fully outside the vehicle.

This point in time can for example be defined by a fixed time value based on experience. Alternatively, a signal can be transmitted to the receiver, code transfer interface or to a different interface of the vehicle lock, for example a button, to detect the completion of the loading process.

Terminating the communication connection to the loading carrier is used as an occurrence for sending the signal to a locking device for the automatic locking of the vehicle door or flap.

A robot or drone then also does not need to be equipped with additional functionalities in order to mechanically close the vehicle door or flap, which also prevents forgetting to close the vehicle door or flap by a person acting as the loading carrier.

In one embodiment, the control unit is configured in such a way that once the unlocked state has been assumed, the vehicle lock is moved to an open state and then to the closed state, the vehicle lock assumes a locked state, in other words, the control unit sends a signal to the locking control device to lock the vehicle lock.

Once loading is completed and the vehicle door or flap has been closed, in other words, the vehicle lock has been moved to the closed state, locking takes places automatically in order to prevent unauthorized access.

In one embodiment, the control unit is configured in such a way that the control unit resets the reference code after a predefined period of time, e.g. an hour and/or after having assumed the unlocked state if the obtained access code matches the reference code. Resetting means deleting, setting to zero or resetting to a predefined value.

Misuse and unwanted access to the vehicle by means of the access code for purposes other than the envisaged loading of the load, can hereby be counteracted.

Above all, the control unit can also reset the reference code, preferably immediately after the control unit has sent the signal to the locking control device for the locking of the vehicle lock, if after assuming the unlocked state, the vehicle lock has been moved to an open state and then finally to the closed state.

In one embodiment, the vehicle lock comprises a load receiving checking device, in particular a load ID scanner, and/or a loading monitoring device, in particular a camera.

The load receiving checking device ensures that the correct load is loaded into the vehicle. With this in mind, a load ID scanner, e.g. a barcode scanner, can be installed in the vehicle lock, notably onto the frame box or near the frame box. A load with a barcode can hereby be identified very reliably. Alternatively, a weight determination device can also be used to determine the weight of the load and then this weight can be compared to a specified weight range in order to identify the load.

The loading monitoring device ensures that the correct loading process is monitored. With this in mind, a camera can be installed in the vehicle lock, notably onto the frame box or near the frame box. For instance, via the cellular connection of the receiver, the loading process can then be monitored visually by the load issuing station or alternatively from a separate monitoring station. Monitoring can be live, i.e. real-time, or in the form of security recordings.

A microphone can be used as an option, in order to be able to convey a voice message to the loading carrier of the load issuing station or have a conversation with the load issuing station through the loudspeaker. The loading monitoring device can also be used as a load receiving checking device to save the need for additional equipment. Scanning a load ID such as for example a barcode, is therefore also essentially possible with a camera as the loading monitoring device.

In one embodiment, the vehicle lock comprises an indicator device, notably LED, and/or a loudspeaker, whereby the indicator device and/or the loudspeaker are preferably integrated in a frame box of the vehicle lock.

By using the indicator device, that is especially space-saving as LEDs, and/or the loudspeaker, this enables an employee acting as the loading carrier, to be prompted to scan the load and to display the result of the incoming goods control or to issue an acoustic signal. For the scanner should only be activated for a very short period of time in order to save resources. This is especially important if the actual scanner is to be used to identify the scanner area and/or to illuminate the area to be scanned.

The loudspeaker can also issue predefined commands such as for example “Scan now, Thank You”.

In addition to this, a loudspeaker facilitates live communication between the loading carrier and the load issuing station, sending station and/or monitoring station.

In one embodiment, confirmation information to acknowledge the successful loading of a specific load into a specific vehicle, can be transmitted via the receiver to the load issuing station or via the code transfer interface to the access code unit of the loading carrier, where this information is then saved.

In one embodiment, lighting equipment can be used that is preferably integrated in the frame box or affixed to it. This enables a load ID, e.g. barcode, to be reliably scanned in especially when using the camera and/or particularly effective monitoring with a camera, especially in otherwise dark surroundings. Furthermore, the lighting equipment can be used to identify the scanner area so that the load ID can be positioned accordingly.

A further aspect of the invention relates to a procedure for the access-controlled loading and/or unloading of a vehicle using a vehicle lock, in particular according to one of the previous embodiments of the vehicle lock according to the invention, comprising a rotary latch and a pawl for latching the rotary latch in a closed state of the vehicle lock, whereby a reference code is received by a receiver of the vehicle lock for the unloading and/or loading, an access code is obtained from a code transfer interface of the vehicle lock and a control unit of the vehicle lock switches the vehicle lock to an unlocked state, when the obtained access code matches the reference code. This can hereby facilitate the very highly automated access-controlled loading of a vehicle. The aforementioned embodiments and examples and definitions can also be applied to the method.

In one embodiment of the method, it is provided for that a load issuing station first sends the reference code to the receiver, then transfers an access code with an identical reference code to a loading carrier, in other words, verbally communicates and/or records it onto an access code unit of the loading carrier, and transfers a load to the loading carrier that is designated for loading into a specific vehicle, and then finally that the loading carrier transports the load to the vehicle, whereby upon reaching the vehicle, the access code is transferred to the code transfer interface, either by means of manual input or contactless, e.g. using the access code unit, and that when the obtained access code matches the reference code, the vehicle door or vehicle flap is unlocked and can be opened so that the load can be loaded.

Exemplary embodiments of the invention are explained in further detail hereinafter on the basis of figures. Features of the execution examples can be combined individually or multiply with the stressed object.

The following are shown:

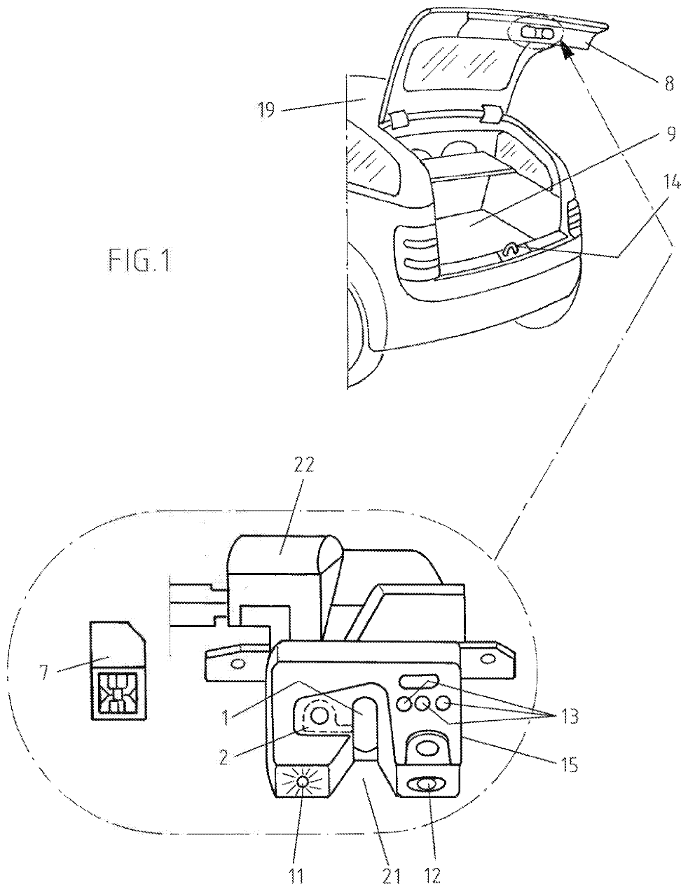

FIG. 1: Example of a vehicle lock according to the invention.

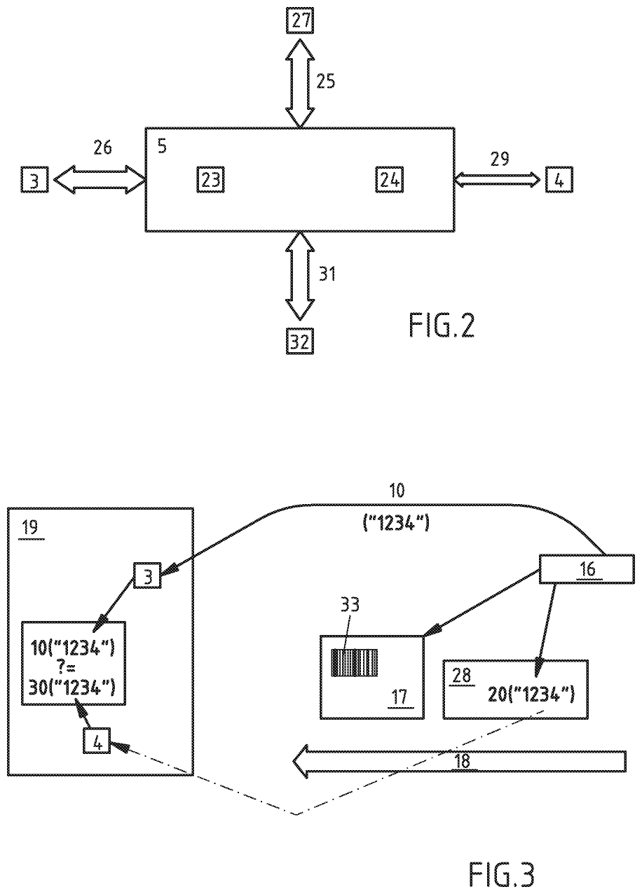

FIG. 2: Diagrammatic representation of a control unit of an exemplary vehicle lock according to the invention and the connected equipment.

FIG. 3: Diagrammatic representation of the method for access-controlled loading and/or unloading of a vehicle using the vehicle lock according to the invention.

FIG. 1 shows an exemplary vehicle lock according to the invention, where the rotary latch 1 and the pawl 2, that is covered by the frame box 15 in FIG. 1 and is therefore only depicted by dot-dashed lines, in particular together with a release lever that is not depicted, is pivotably attached to a frame plate or frame box 15 comprising the frame plate. The frame box 15 is preferably made from metal and is usually secured to the motor vehicle chassis with screws.

The frame box 15 has an inlet slot 21 to accommodate a locking bolt 14. A locking mechanism comprises the rotary latch 1 to accommodate the locking bolt 14 and the pawl 2 to latch the rotary latch 1.

The rotary latch 1 normally has a fork-shaped inlet slot formed by a load arm and a catching arm in which the locking bolt 14 of a vehicle door or flap 8, in particular a trunk flap, goes when the vehicle door or flap 8 is closed.

With the aid of the catching arm, the locking bolt 14 then rotates the rotary latch 1 from an open position to a closed position. If the rotary latch 1 has reached the closed position, it is latched via the pawl 2 in this position and the vehicle lock assumes a closed state. The locking bolt 14 can no longer leave the inlet slot of the rotary latch 1 as this is prevented by the load arm. This latching position is known as the main latching position.

There is a vehicle lock, in particular a motor vehicle lock, with a second latching position, namely the so-called pre-latching position. The aim of the pre-latching position is to catch the relevant vehicle door or flap 8 if it does not reach the main latching position during closure.

In the pre-latching position the rotary latch 1 is consequently not completely closed. However, an opening movement of the rotary latch 1 is already prevented by a pawl 2. The area of the rotary latch 1 which accommodates the pawl 2 in this position is described as a pre-latch.

Finally, in the main latching position the rotary latch 1 is completely closed. The pre-latch is therefore a transitional state between the open state and the main latch and is envisaged for safety reasons.

In one embodiment, a blockade lever can also be used to hold the pawl in the main latching position and/or an ejector lever to swivel the pawl out of the latch with the rotary latch.

The vehicle lock in FIG. 1 has a housing 22 and a SIM card slot 6 that is covered by the housing 22, for a SIM card 7 or eSIM. With the aid of the SIM card slot 6 and the SIM card 7 and a mobile telephone unit, the receiver can communicate, in other words, exchange data, with the load issuing station 16.

The load issuing station 16 thus sends the reference code 10 to the vehicle lock and the simultaneous monitoring of the loading process and/or unloading process in real-time is facilitated by means of the camera 12. Recordings from the camera 12 during the monitoring of the loading and/or unloading process can be saved as video footage for later viewing. Alternatively or additionally, it is also possible that the recordings from the camera 12 are sent for example via a data stream to an external unit, for example a Smartphone of a vehicle owner or a screen at the head office of a delivery service.

The vehicle lock 1 comprises a code transfer device 4 and a control unit 5. These are not shown in FIG. 1 as these electronic components are inside the housing 22.

A load ID scanner 11 for scanning a barcode 33 of a load 17, LEDs 13 as display equipment and the camera 12 are all visibly affixed to the vehicle lock. Exactly three LEDs 13 should be used, preferably in the colors green, yellow and red. Alternatively, at least 1 or two, but less than 5 LEDs 13 can also be used.

As shown in FIG. 1, the vehicle lock is affixed to a vehicle flap 8 on the tailgate side of the vehicle 19 and is only externally visible and accessible when the vehicle flap 8 is in an open state.

The locking bolt 14 is affixed to the vehicle chassis and engages with the vehicle lock when the vehicle flap 8 is closed.

FIG. 2 shows the control unit 5 that comprises a processor 23 and memory 24, onto which are stored above all for example the reference code 10 and/or instructions that can be executed by the processor, i.e. loadable software code.

A vehicle control interface 25 creates a data connection between the control unit and external control equipment 27 such as for example the central locking system, the DCU (Door Control Unit) and/or the ECU (Electronic Control Unit) of the vehicle. Access to a multitude of vehicle data and status information and/or the triggering to switch the vehicle lock to a locked or unlocked state by the control unit 5 and/or the actuation of the automatic opening and/or locking device by the control unit 5, can hereby be facilitated.

A receiver interface 26 presents a data connection between the control unit 5 and the receiver 3. The control unit 5 can hereby receive the reference code 10 from the receiver 3 and for example exchange data and/or communicate with a load issuing station 16 via the receiver 3, preferably by means of a cellular connection that also facilitates the exchange of data and not just an acoustic signal exchange, e.g. via GPRS, UMTS, 3G, 4G etc. Data about the delivery can also be exchanged with the load issuing station 16 via the receiver 3.

For example, the control unit 5 can be set up in such a way that a notification is sent to the load issuing station 16 through the reception of the reference code 10, thus through a lock opening and finally through the completed closure of the motor vehicle lock after loading and/or unloading. Recordings from the camera 12 can also be sent to the load issuing station 16. Additional data such as loading status, vehicle load capacity or the like can also be exchanged with an external site via the receiving unit 3. A data exchange can also take place via the receiving unit 3 for the access-controlled loading and/or unloading with a vehicle owner, for instance via an App on a Smartphone of the vehicle owner.

A code transfer interface connection 29 facilitates the data exchange in particular via a data line between the control unit 5 and the code transfer interface 4.

The code transfer interface 4 can hereby forward the obtained access code 30 to the control unit 5. Above all, the control unit 5 can in turn for example transfer data that represents a receipt, to the code transfer interface 4 so that the code transfer interface 4 can transfer the receipt to the access code unit 28 of the loading carrier 18.

A functional device interface 31 creates a data connection between the control unit 5 and at least one functional device 32, e.g. a load receiving checking device, in particular a load ID scanner 11, a loading monitoring device, notably camera 12, an indicator device, notably LED 13, a loudspeaker and/or a lighting device.

At least one functional device 32 can therefore be run and controlled by the control unit 5 through a very simple structure.

FIG. 3 depicts an example of the method for the access-controlled loading according to the abovementioned aspect of the invention.

A reference code 10 and an access code 20 that is identical to the reference code is generated at a load issuing station 16 or by a load issuing station 16 that is depicted for example and for purely illustrative purposes, as “1234”.

The reference code 10 is sent at the load issuing station 16 or by the load issuing station 16 to the receiver 3 of the vehicle lock of the vehicle 19 that then sends the reference code 10 to the control unit 5.

Furthermore, the access code 20 is transmitted at the load issuing station 16 or by the load issuing station 16 to the access code unit 28 of the loading carrier 18 and a load 17 that is to be loaded into the vehicle 19, is transferred to a loading carrier 18.

The loading carrier 18 then transports the load 17 to the vehicle 19. As soon as the loading carrier 18 and with it its access code unit 28 are within a predefined range of the vehicle lock, in other words less than a certain distance away from vehicle, the loading carrier 18 transfers, preferably automatically, the access code by means of the access code unit 28 to the code transfer interface 4 that sends the received access code 30 to the control unit 5.

With the aid of a comparison module, the control unit 5 then compares whether the reference code 10 matches the obtained access code 30, which for instance is the case in the example shown in FIG. 3.

If it is not a match, the vehicle lock remains in a locked state. If however it does match, as shown in the example in FIG. 3, then the control unit 5 sends a signal to a locking control device, e.g. to the central locking system, DCU and/or ECU, to unlock the vehicle lock.

The vehicle flap 8 can now be opened so that the loading carrier 18 can load the vehicle 19 with the load 17.

A barcode 33 as shown in FIG. 3 for example acts as a load ID for the purposes of incoming goods control, preferably with a scanner or camera that can be integrated in the vehicle lock.

Access-controlled unloading follows the same process, the only difference is that the loading carrier 18 removes the load 17 previously stored in the vehicle 19.

With a combined loading and unloading process, at least part of the load 17 previously stored in the vehicle 19 is unloaded by the loading carrier 18 and a new load 17 is loaded into the vehicle 19.

1. A vehicle lock comprising:
a locking mechanism having a rotary latch and a pawl for latching the rotary latch when the vehicle lock is in a closed state;
a receiver for receiving a reference code for a loading and/or unloading process;
a code transfer interface for obtaining an access code; and
a control unit which is configured to control the vehicle lock, wherein the vehicle lock assumes an unlocked state when the obtained access code matches the reference code.

2. The vehicle lock according to claim 1, wherein the receiver is surrounded by a housing of the vehicle lock.

3. The vehicle lock according to claim 1, wherein the receiver includes a SIM card slot for a SIM card or eSIM and/or a mobile telephone unit.

4. The vehicle lock according to claim 1, wherein the code transfer interface is configured for transmitting the access code to the code transfer interface via contactless transmission.

5. The vehicle lock according to claim 1, wherein the code transfer interface is configured to transmit the access code within a distance from the vehicle lock that is less than 100 m to the code transfer interface.

6. The vehicle lock according to claim 1, wherein the code transfer interface is an NFC interface, an RFID interface, a Bluetooth interface and/or a WLAN interface.

7. The vehicle lock according to claim 1, wherein the control unit is configured to send a signal to unlock a loading area or trunk when the obtained access code matches the reference code.

8. The vehicle lock according to claim 1, wherein the control unit is configured to send a signal to an opening device for an automatic opening of a vehicle door or flap when the obtained access code matches the reference code.

9. The vehicle lock according to claim 8, wherein when the loading process has been completed, the control unit is configured to send a signal to a locking device for an automatic locking of the vehicle door or flap.

10. The vehicle lock according to claim 1, wherein after the vehicle lock assumes the unlocked state, the control unit is configured to move the vehicle lock to an open state and then to the closed state, in which the vehicle lock assumes a locked state.

11. The vehicle lock according to claim 1, wherein the control unit is configured to reset the reference code after a predefined period of time and/or after the vehicle lock has assumed the unlocked state if the obtained access code matches the reference code.

12. The vehicle lock according to claim 1 further comprising a load receiving checking device.

13. The vehicle lock according to claim 1 further comprising an indicator device.

14. A method for access-controlled loading of a vehicle using the vehicle lock according to claim 1, the method comprising:
receiving the reference code using the receiver of the vehicle lock;
obtaining the access code from the code transfer interface of the vehicle lock; and
switching the vehicle lock to the unlocked state when the obtained access code matches the reference code using the control unit.

15. The method according to claim 14 further comprising:
sending the reference code to the receiver using a load issuing station;
transferring the access code that is identical to the reference code to a loading carrier using the load issuing station;
transferring a load to the loading carrier that is designated for loading into a specific vehicle;
transporting the load to the vehicle using the loading carrier;
transferring the access code is transferred to the code transfer interface upon reaching the vehicle and if the received access code matches the reference code; and
unlocking a vehicle door or vehicle flap of the vehicle to open the vehicle door or vehicle flap so that the load can be loaded.

16. The vehicle lock according to claim 1, wherein the receiver is directly connected to a housing of the vehicle lock.

17. The vehicle lock according to claim 5, wherein the code transfer interface is configured to transmit the access code within a distance from the vehicle lock that is less than less than 10 m to the code transfer interface.

18. The vehicle lock according to claim 17, wherein the code transfer interface is configured to transmit the access code within a distance from the vehicle lock that is less than less than 1 m to the code transfer interface.

19. The vehicle lock according to claim 12, wherein the load receiving checking device includes at least one of a load ID scanner and a camera.

20. The vehicle lock according to claim 13, wherein the indicator device is a LED, and/or a loudspeaker, that is preferably integrated in a frame box of the vehicle lock.
